(19) United States
(12) Patent Application Publication
(10) Pub. No.: US 2015/0370649 A1
(43) Pub. Date: Dec. 24, 2015

(54) Sending a Request to a Management Service

(71) Applicant: HEWLETT-PACKARD DEVELOPMENT COMPANY, L.P., Houston, TX (US)

(72) Inventors: Albrecht Schroth, Boeblingen (DE); Philipp Krauss, Boeblingen (DE); Joseph S. Ficara, Southborough, MA (US); Kanthimathi Vedaraman, Bangalore (IN)

(21) Appl. No.: 14/764,988

(22) PCT Filed: Feb. 27, 2013
(86) PCT No.: PCT/US13/27968

§ 371 Date: Jul. 31, 2015

(51) Int. Cl. G06F 11/14; G06F 17/30

(52) U.S. Cl. CPC G06F 11/1461; G06F 11/1471; G06F 17/30424; G06F 2201/84

(57) ABSTRACT

Sending a request to a management service includes sending a request on behalf of a client to a management service that coordinates backup and recovery services in communication with a policy engine that determines backup and recovery rules and sending metadata about the request to the management service.

### BACKGROUND

Backup and recovery systems are designed to copy and archive a client device's data such as files or documents from the client device and store the data as backup data in a data repository. The data repository may be a flash drive, a hard drive disk, a secured server, or an unsecured server. If the client device experiences a data loss event, the client device's data can be recovered to the state where the backup was created. In such an event, the client device's data can be recovered by retrieving the backed up data and loading the backed up data onto the client device.

### BRIEF DESCRIPTION OF THE DRAWINGS

The accompanying drawings illustrate various examples of the principles described herein and are a part of the specification. The examples do not limit the scope of the claims.

FIG. 1 is a diagram of an example of sending system in communication with a management system, according to the principles described herein.

FIG. 2 is a flowchart of an example of a method for sending a request to a management system, according to the principles described herein.

FIG. 3 is a diagram of an example of sending system, according to the principles described herein.

FIG. 4 is a diagram of an example of sending system, according to the principles described herein.

FIG. 5 is a flowchart of an example of a method for sending a recovery request, according to the principles described herein.

FIG. 6 is a flowchart of an example of a method for sending a backup request, according to the principles described herein.

Throughout the drawings, identical reference numbers designate similar, but not necessarily identical, elements.

### DETAILED DESCRIPTION

As noted above, systems can backup and recover data in client devices. To execute backup and recovery events, backup and recovery systems use management services and service stations to coordinate backup requests and recover requests as well as perform any background metadata processing. The actual backup and recovery of data is generally executed by separate agents. Agents may be used to perform backup requests or recovery requests, and may be downloaded to clients from the management service. Commercially available agents are often platform specific which limits the types of platforms on which an agent can be deployed. As a result, the management service stores program instructions for multiple platform specific agents. Consequently, each platform specific agent ties up memory and resources in the management service.

To further drain the management service's resources, models and other information that affect which data to backup and/or store are also stored in the management service's resources. Thus, a management service's resources are limited and handling multiple requests simultaneously with such limited resources increases the risk of executing the requests with long processing times, errors, failures, or other adverse consequences.

If a management station and a service station are heavily loaded with backup requests and recovery requests, the performance of the management station is impacted. Such an impact may lead to a single point of failure. Further, the scalability of a backup and recovery system is limited due to the agents tightly coupled to the management station for each platform.

The principles described herein include a method for sending a request to a management service. Such a method includes a management service that uses smart agents that are platform independent or platform non-specific. Such platform independent agents reduce the number of agents used to perform backup requests and recovery requests. This allows the management service operate in a more efficient manner.

The principles described herein include a method for sending a request to a management service. Such a method includes sending a request on behalf of a client to a management service in communication with a policy engine. The policy engine determines a policy or rules for backup requests and recovery request. The method further includes sending metadata about the request to the management service. Thus, a request is sent to backup a client device's data or to recover a client device's data to where a backup of the client device's data was last created.

The present specification also describes a system for sending a request to a management service. The system includes a policy engine to determine a policy or rules for backup requests and recovery request. In one example, a client defines a policy for a backup request and/or a recovery request. The policy engine determines what data is to be protected, where the data is to be protected, and when the data is to be protected. The system further includes a management service in communication with the policy engine. The management service receives backup requests and recovery requests from the policy engine. The management service is used to coordinate backup requests and recovery requests.

In response to receiving a backup or recovery request, the backup request or the recovery request is sent from the management service and is received by an agent service. The agent service is a representational state transfer (REST) based web service that exposes interfaces to a user using a graphical user interface (GUI). The exposed interfaces are used to present, to a user, options for a backup or recovery request. Further, the agent service facilitates a backup or recovery request on a client device based on the backup or recovery request from the GUI. The agent service executes a backup request or recover request by instantiating a smart agent. The smart agent is an engine that performs the actual request. In one example, the smart agent presents to a user, using a client device's user interface, a GUI. The GUI displays options to backup a client device's data, recover a client device′ data, schedule events, query the client's data, change policy settings, report, audit, other commands, or combinations thereof. The options to backup the client device's data may include backing up specific data on the client device or backing up all the data on the client device. Further, options to recover the client device's data may include recovering specific data for the client device or recovering all the data for the client device. By using the GUI, the user can determine the appropriate backup request or recovery request. In some examples, the user commands the agent through the GUI to make a request, such as a back-up request, without specifying details about the back-up. In such an example, the agent may determine how to execute the request in an appropriate manner. In a similar example, the agent can determine how to execute a recovery request when the user does not provide details about how to execute the recovery request.

The present specification also describes a computer program product for sending a request to a management service that includes computer-readable instructions on a non-transitory medium, that, when executed by a processor, cause a client device's data to be backup or recovery according to the backup request or recovery request. A non-transitory medium is a storage medium excluding signals and other transitory media per se. However, volatile memory devices are non-transitory media.

In the following description, for purposes of explanation, numerous specific details are set forth in order to provide a thorough understanding of the present systems and methods. It will be apparent, however, to one skilled in the art that the present apparatus, systems, and methods may be practiced without these specific details. Reference in the specification to “an example” or similar language means that a particular feature, structure, or characteristic described in connection with that example is included as described, but may not be included in other examples.

As will be described in detail below, a method for sending a request to a management service includes sending a request on behalf of a client to a management service in communication with a policy engine and sending metadata about the request to the management service.

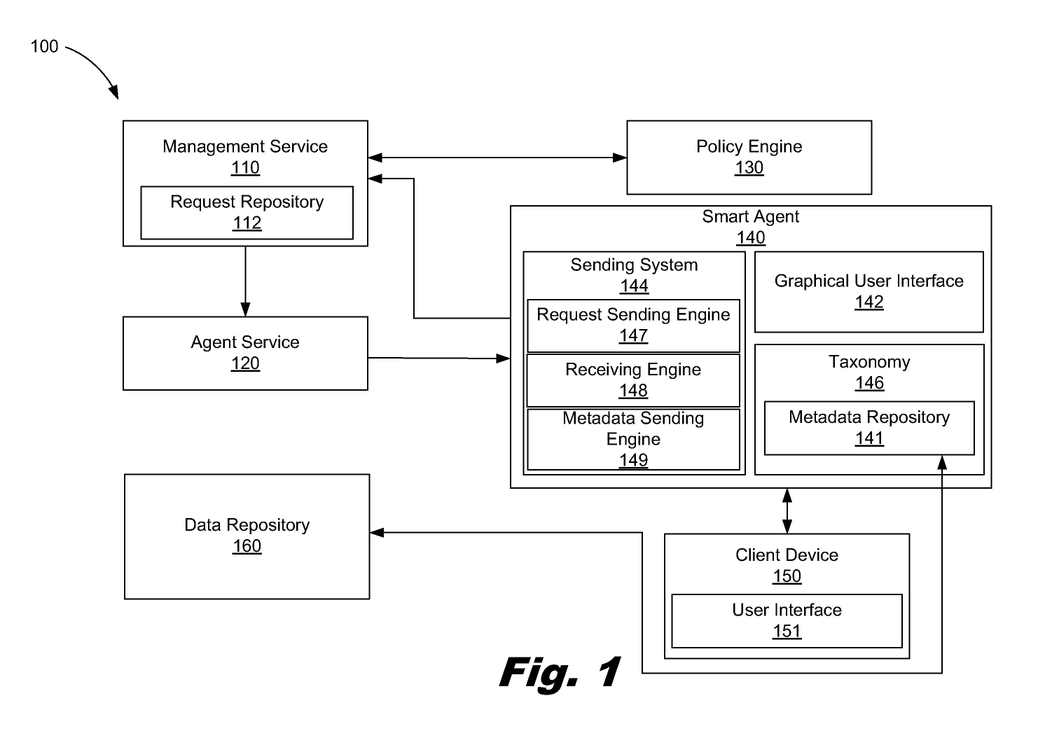

Referring now to the figures, FIG. 1 is a diagram of an example of sending a request to a management system, according to the principles described herein. The backup and recovery systems are designed to copy and archive a client device's data such as files, documents, or any other type of data from the client device and store the data as backup data in a data repository. For example, a data repository may be a flash drive, a hard drive disk, a secured server, or an unsecured server, or any appropriate storage medium to store backed up data. If the client device experiences a data loss event, the client device's data is recovered to the state where the backup was created. For example, the client device's data is recovered by retrieving the backed up data and loading the backed up data onto the client device.

As mentioned above, the system (100) includes a policy engine (130) to determine what data is to be protected and where it is to be protected. Such decisions may be based on policies stored in a policy engine (130). The policy engine (130) determines what files, documents, or any other type of data from a client device are to be backed up or recovered. In one example concerning a decision of where to store data, a client, such as a backup administrator, defines a policy or rules for a backup request. For example, during a backup request the client determines if the data being backed up is to be encrypted or not encrypted. If the data is to be encrypted, the data is stored on a secured server. In one example, if the data is not to be encrypted, the data is stored on an unsecured server.

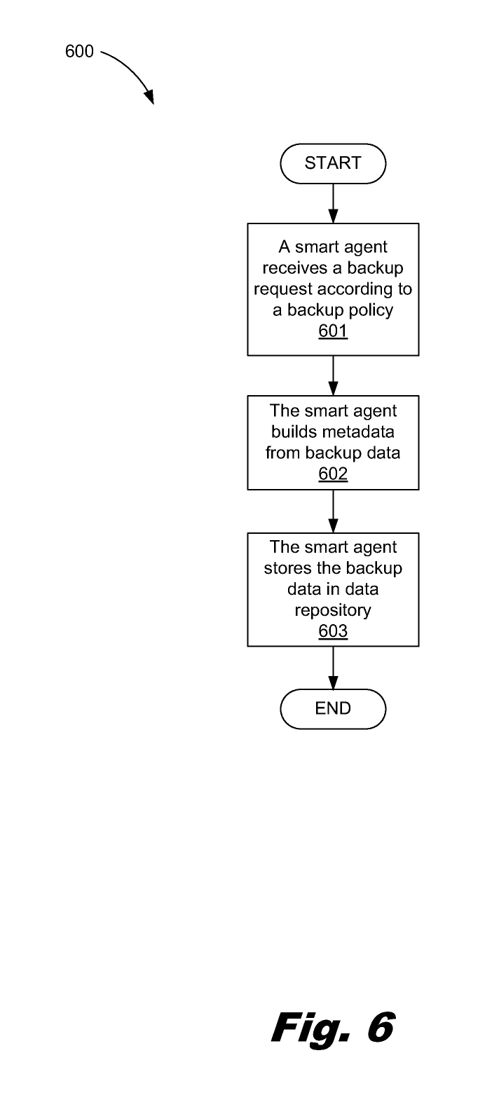

Further, the client can determine the frequency of backups performed on the data. For example, the policy may have a rule indicating that imperative data is to be backed up after a specified amount of time, such as every 15 minutes. In other examples, the policy may have a rule indicating that non-imperative data may be backed up at a different time interval, such as once a day. Further, the client determines how long backed up data is to be stored. For example, the policy may have a rule indicating that data is to be stored for up to two years. If the data is not accessed within two years, the data is to be deleted. Further, the client determines the type of data that is to be backed up. For example, the policy may have a rule indicating that data having a .pdf extension are backed up. While this example has been described with reference to specific policy rules, any other appropriate policy may be implemented to determine rules for data to be backed up. The process for a backup request can be executed using the examples detailed in FIG. 6 and described later in this specification.

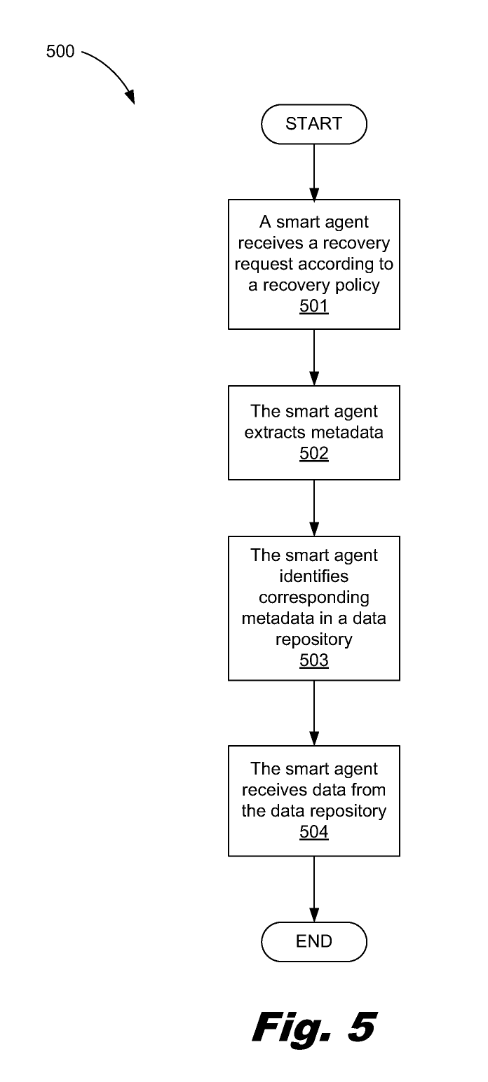

In another example, a client defines a policy or rules for a recovery request. In such an example, the client can define a policy to recover all backup data based on age, such as all data that is less than two years old. Further, the client can determine the type of files that are to be recovered. In such an example, the client can define that files having a .pdf extension are to be recovered from the backed up data and loaded onto a client device (150). Further, any other appropriate policy may be implemented to determine data to be recovered. The process for a recovery request can be done using the examples detailed in FIG. 5 and described later in this specification.

The system (100) also includes a management service (110). The management service (110) is used to coordinate backup requests and recovery requests. In one example, a backup request is sent from the policy engine (130) to the management service (110). The backup request is stored in a request repository (112) on the management service (110). The backup request remains stored in the request repository (112) until the management service (110) determines the backup request is to be executed according to the backup request's policy. The management system (110) determines the backup request is to be executed. In such an example, the backup request is sent to an agent service (120).

In another example, a recovery request is sent from the policy engine (130) to the management service (110). The recovery request is stored in a request repository (112) on the management service (110). The recovery request remains stored in the request repository (112) until the management service (110) determines the recovery request is to be executed. The management system (110) determines the recovery request is to be executed. In such an example, the recovery request is sent to an agent service (120). As mentioned above, an agent service (120) is a representational state transfer (REST) based web service that exposes interfaces to a user via a GUI. Further, the agent service (120) facilitates a request on a client device (150) based on the request from the GUI (142). In one example, an agent service (120) is used to execute a backup or recovery request received from the management service (110).

The agent service (120) executes the backup or recovery request by instantiating an appropriate smart agent (140). In one example, the agent service (120) reformats any received data for a backup or recovery request into an optimized format for a smart agent (140). Further, the agent service (120) sets up configuration information for a smart agent (140) to execute the backup or recovery request. Additionally, the agent service (120) monitors the functionality of the smart agent (140). Once a smart agent is instantiated, a client, using a client device's (150) user interface (151), interacts with the smart agent (140) to perform a backup or recovery request. In one example, a smart agent (140) uses a GUI (142) to present to a client options to backup or recover data according to the backup or recovery request received from the agent service (120). In another example, the GUI (142) presents, to a user, options to query a client device, change a policy setting, report, or audit. As mentioned above, the GUI (142) is a web based GUI that uses interfaces exposed by the agent service (120).

Further, the GUI's (142) modules can be developed independent of the management service (110). In one example, the GUI (142) uses the query client, change a policy setting, report, or audit interfaces of the agent service (120) to present options, to a user, tasks that a smart agent (140) can perform. In one example, the options presented to a client in the GUI (142) are derived from terms in a taxonomy (146). The source of the taxonomy (146) is handled by the smart agent (140). For example, the taxonomy (146) uses a metadata repository (141) to determine the type of data the smart agent (140) is protecting. The taxonomy (146) may include terms for directories, files, virtual machines, other terms, or combinations thereof. This enables the management service (110) to be implemented in a generic manner. For example, the management service (110) queries the smart agent (140) for terms contained in the taxonomy (146) and the smart agent (140) adjusts itself by utilizing the terms. Additionally, a smart agent (140) is instantiated in a dynamic manner such that the smart agent (140) is not platform specific.

In response to receiving a change policy setting request, the agent service (120) instantiates the appropriate smart agent (140) to execute a change policy setting request. In one example, a change policy setting request may change a backup request policy or a recovery request policy of an application or database. A GUI (142) is presented to a user through a client device's (150) user interface (151) to change a policy setting. The change policy setting request is made from a GUI (142) using a REST based instruction sent to the agent service (120). As will be described below, the agent service (120) invokes the appropriate smart agent (140) to perform a change policy setting request. Further, a policy setting may be based on a backup device or scheduling of a backup request. In one example, a backup device may be a tape, a disk, a cloud, or any other appropriate combination thereof.

In response to receiving a backup request, the agent service (120) instantiates the appropriate smart agent (140) to execute the backup request. The GUI (142) is presented to a client through a client device's (150) user interface (151) to backup data on a client device (150). If the client desires to backup all data, the client can use the GUI (142) to backup the data contained on the client device (150) according to a backup policy.

The smart agent (140) can build metadata offline for the data being protected after backup. The metadata built for the data being protected after backup is stored in a metadata repository (141). Further, building the metadata offline can use a format that is open and not bound by any closed format. For example, the metadata may be built using a JSON. JSON is a text-based open standard design for human readable data interchange. In one example, JSON is used to represent simple data structures and associative arrays. By using the JSON, the smart agent's (140) data path is open and building metadata is done offline. Further the amount of data which can be protected and the time taken to build the metadata is reduced. The process for a backup request can be done using the examples detailed in FIG. 6 and described later in this specification.

In another example, the agent service (120) receives a recovery request and the agent service (120) instantiates the appropriate smart agent (140) to execute the recovery request. As noted above, a GUI (142) is presented to a client through a client device's (150) user interface (151) to recover data for the client device (150). The user, interacting with the GUI (142), can select an option to recover all data. In such an example, the data associated with the recovery request is recovered and loaded onto the client device (150). The process for a recovery request can be done using the examples detailed in FIG. 5 and described later in this specification.

Further, the smart agent (140) includes a sending system (144). The sending system (144) has a request sending engine (147), a receiving engine (148), and a metadata sending engine (149). The engines represent the program instructions to carry out their indicated functions. The request sending engine (147) sends a backup request or a recovery request to the management service (110) according to a backup policy or a recovery policy. The receiving engine (148) receives the backup or recovery request. The metadata sending engine (149) sends metadata associated with the backup request or the recovery request to the appropriate part of the system (100). For example, the appropriate part of the system (100) may be the management service (110).

In response to receiving a query client request, the agent service (120) instantiates the appropriate smart agent (140) to execute the query client request. A GUI (142) is presented to a user through a client device's (150) user interface (151) to query the client. In one example, a query client request is for integrations such as a file system, a VmWare environment, a structured query language (SQL) application, an exchange application, or an oracle application. Based on the type of integration for a query client request received using the GUI (142), the agent service (120) invokes a respective browse agent corresponding to the client. In keeping with the given example, the browse agent gives an appropriate output in JSON. The agent service (120) processes and exposes the query client request as a REST based web service for the GUI (142) in JSON to further query or execute a policy.

In response to receiving a report or audit request, the agent service (120) instantiates the appropriate smart agent (140) to execute the report or audit request. In one example, the agent service (120) exposes a report or audit interface through a GUI (142) for a user to execute a report or audit. The agent service (120) instantiates a report or audit module on the client device (150) to collect data and present the data to a user using the GUI (142) in JSON.

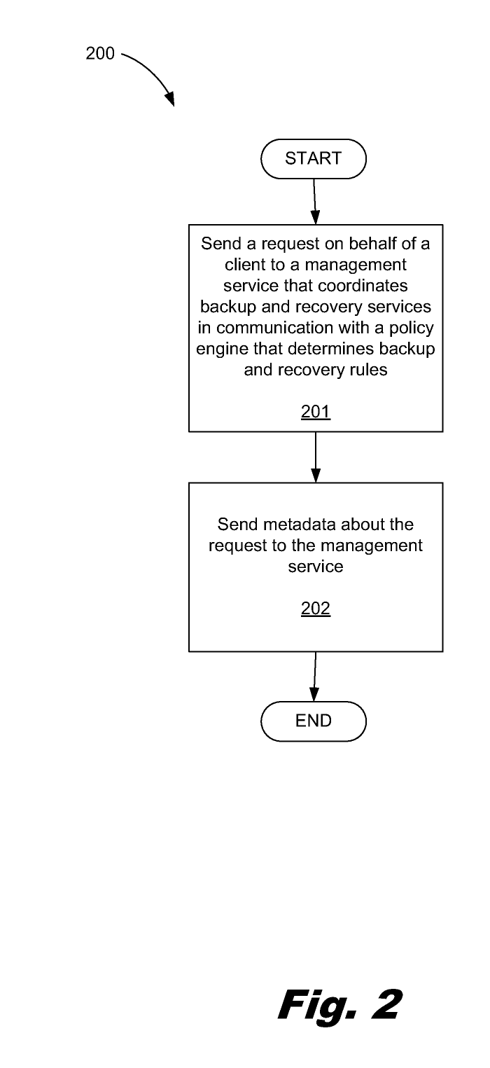

FIG. 2 is a flowchart of an example of a method (200) for sending a request to a management system, according to the principles described herein. In this example, the method (200) includes sending (201) a request on behalf of a client to a management service that coordinates backup and recovery services in communication with a policy engine that determines backup and recovery rules and sending (202) metadata about the request to the management service.

The request may be a backup request, a recovery request, schedule request, a query request, another request, or combinations thereof. As mentioned above, a client can define a policy or rules for a backup operation. For example, a client can determine if during a backup operation the data being backed up is to be encrypted or not encrypted. Further, a client can determine the frequency of backups performed on the data. For example, imperative data may be backed up after a specified amount of time, such as every 15 minutes. In another example, non-imperative data may be backed up once a day. Further, a client determines how long backed up data is to be stored. For example, data may be stored for up to two years. Further, a client determines the type of files that are to be backed up. For example, files having a .pdf extension are backed up. Further, any other appropriate policy may be implemented to determine the data to be backed up. Once a backup request's policy is determined, the backup request is sent (201) to a management service (FIG. 1, 110).

In other examples, a client defines a policy or rules for a recovery request. For example, a client may define a policy to recover all data less than two years old. Further, a client determines the type of files that are to be recovered. For example, files having a .pdf extension are recovered. Further, any other appropriate policy may be implemented to determine the data to be recovered. Once a recovery request's policy is determined, the recovery request is sent (201) to a management service (FIG. 1, 110).

The metadata about the request is sent (202) to the management service. The process for a backup request can be done using the examples detailed in FIG. 5 and described later in this specification. In another example, recovery metadata is sent (201) to the management service (FIG. 1,110). The process for a recovery request can be done using the examples detailed in FIG. 5 and described later in this specification.

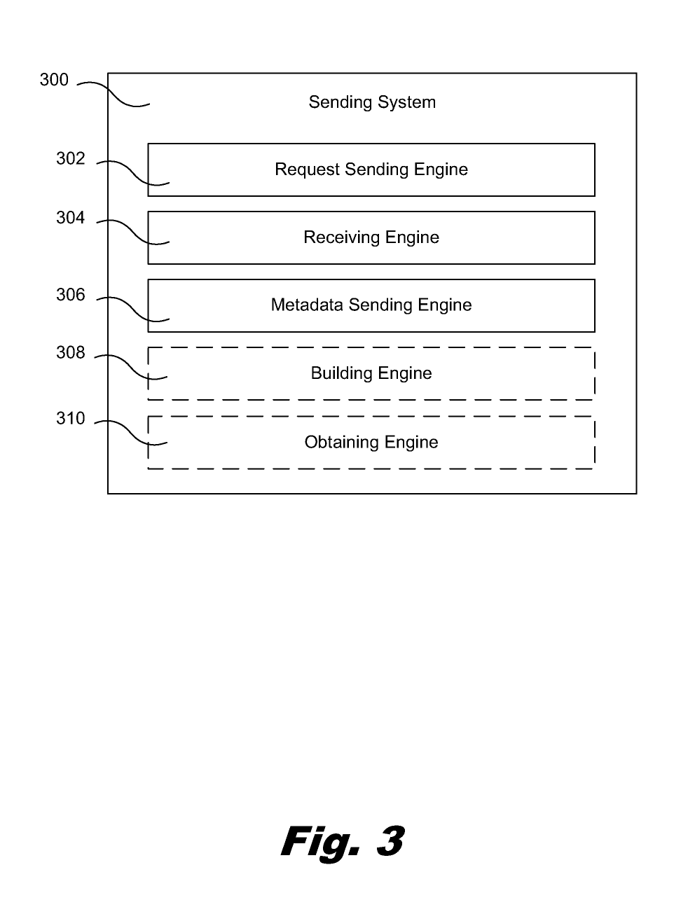

FIG. 3 is a diagram of an example of sending system (300), according to the principles described herein. The sending system (300) includes a request sending engine (302), a receiving engine (304), and a metadata sending engine (306). In this example, the system (300) also includes a building engine (308), and an obtaining engine (310). The engines (302, 304, 306, 308, 310) refer to a combination of hardware and program instructions to perform a designated function. Each of the engines (302, 304, 306, 308, 310) may include a processor and memory. The program instructions are stored in the memory and cause the processor to execute the designated function of the engine.

The request sending engine (302) sends a request on behalf of a client to a management service in communication with a policy engine. As mentioned above, a client defines a policy or rules for a backup request or a recovery request. Once a policy is defined, the policy is sent to a management service (FIG. 1, 110). In one example, a backup request is sent from a policy engine (FIG. 1, 130) to a management service (FIG. 1, 110). In another example, a recover request is sent from a policy engine (FIG. 1, 130) to a management service (FIG. 1, 110).

The receiving engine (304) receives a backup request or a recovery request on behalf of a client. In one example, receiving a backup request or a recovery request on behalf of a client includes receiving a query from the management service about metadata relevant to type request of request received. In one example, a backup request from the management service is received. The management services queries for metadata relevant to the backup request. In another example, a recovery request from the management service is received. The management services queries for metadata relevant to the recovery request.

The metadata sending engine (306) sends metadata relevant to a backup request or a recovery request to the management service. In one example, metadata for a backup request is sent to the management service. In another example, metadata for a recovery request is sent to the management service (FIG. 1,110).

The building engine (308) builds metadata offline in a metadata repository. In one example, a backup request is received. Thus, metadata is built offline and implemented through the management service (FIG. 1,110).

The obtaining engine (310) obtains a client's input to send a request. In one example, a client input sends a backup request. In another example, a client input sends a recovery request.

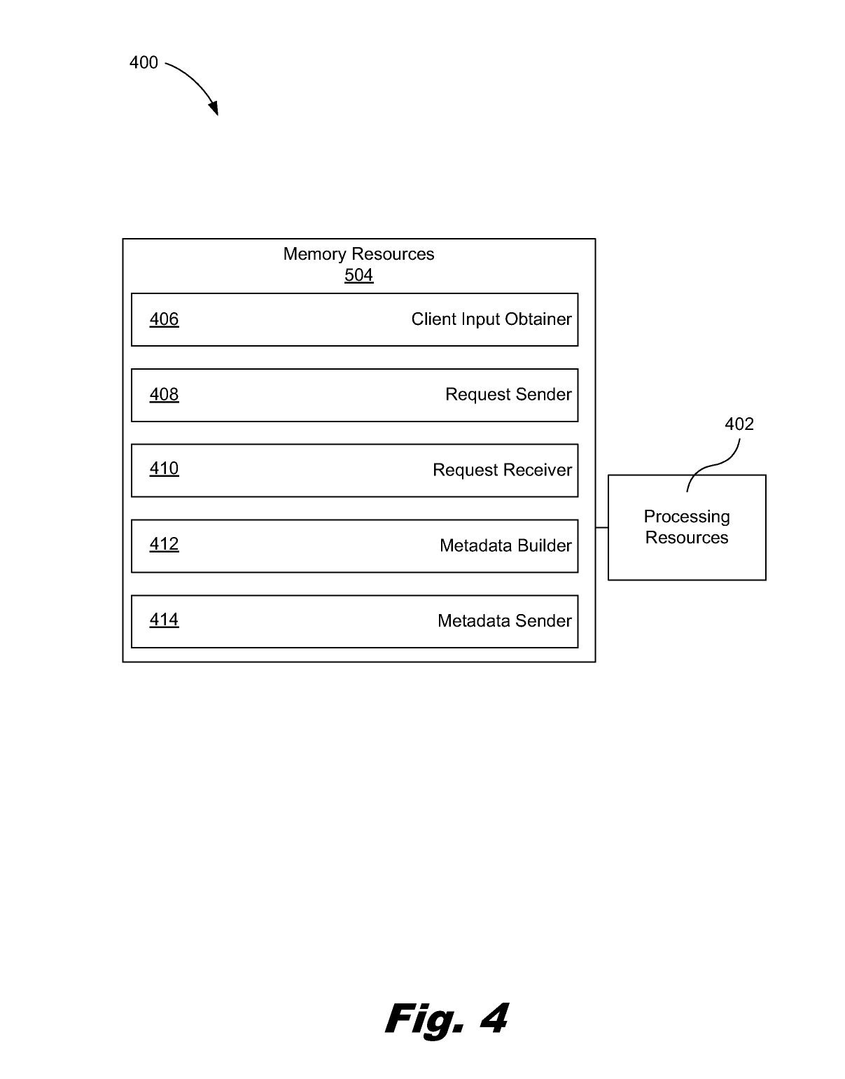

FIG. 4 is a diagram of an example of sending a request to a management system (400), according to the principles described herein. In this example, sending a request to a management system (400) includes processing resources (402) that are in communication with memory resources (404). Processing resources (402) include at least one processor and other resources used to process programmed instructions. The memory resources (404) represent generally any memory capable of storing data such as programmed instructions or data structures used by the sending a request to a management system (400). The programmed instructions shown stored in the memory resources (404) include a client input obtainer (406), a request sender (408), a request receiver (410), a metadata builder (412), and a metadata sender (414).

The memory resources (404) include a computer readable storage medium that contains computer readable program code to cause tasks to be executed by the processing resources (402). The computer readable storage medium may be tangible and/or non-transitory storage medium. The computer readable storage medium may be any appropriate storage medium that is not a transmission storage medium. A non-exhaustive list of computer readable storage medium types includes non-volatile memory, volatile memory, random access memory, memristor based memory, write only memory, flash memory, electrically erasable program read only memory, or types of memory, or combinations thereof.

The client input obtainer (406) represents programmed instructions that, when executed, cause the processing resources (402) to obtain a client's input to send a request. The request sender (408) represents programmed instructions that, when executed, cause the processing resources (402) send a request on behalf of a client to a management. The request receiver (410) represents programmed instructions that, when executed, cause the processing resources (402) to receive a query from the management service for metadata relevant to the request. The metadata builder (412) represents programmed instructions that, when executed, cause the processing resources (402) to build metadata offline in a metadata repository. The metadata sender (414) represents programmed instructions that, when executed, cause the processing resources (402) to send metadata to the management service.

Further, the memory resources (404) may be part of an installation package. In response to installing the installation package, the programmed instructions of the memory resources (404) may be downloaded from the installation package's source, such as a portable medium, a server, a remote network location, another location, or combinations thereof. Portable memory media that are compatible with the principles described herein include DVDs, CDs, flash memory, portable disks, magnetic disks, optical disks, other forms of portable memory, or combinations thereof. In other examples, the program instructions are already installed. Here, the memory resources can include integrated memory such as a hard drive, a solid state hard drive, or the like.

In some examples, the processing resources (402) and the memory resources (404) are located within the same physical component, such as a server, or a network component. The memory resources (404) may be part of the physical component's main memory, caches, registers, non-volatile memory, or elsewhere in the physical component's memory hierarchy. Alternatively, the memory resources (404) may be in communication with the processing resources (402) over a network. Further, the data structures, such as the libraries, may be accessed from a remote location over a network connection while the programmed instructions are located locally. Thus, the recommendation system (400) may be implemented on a user device, on a server, on a collection of servers, or combinations thereof.

The sending a request to a management system (400) of FIG. 4 may be part of a general purpose computer. However, in alternative examples, the sending a request to a management system (400) is part of an application specific integrated circuit.

FIG. 5 is a flowchart of an example of a method for a recovery request, according to the principles described herein. As mentioned above, a recovery request is sent to a management service (FIG. 1, 110) on behalf of a client according to a defined recovery policy. As mentioned above, a client defines a policy or rules for a recovery request. For example, the client may define a policy to recover data less than two years old. Further, the client determines the type of files that are to be recovered. For example, files having a .pdf extension are recovered. Further, any other appropriate policy may be implemented to determine the data to be recovered. As mentioned above, a management service (FIG. 1, 110) coordinates the recovery request and the recovery request is executed by an agent service (FIG. 1, 120) by instantiating a smart agent (FIG. 1, 140). The smart agent (FIG. 1, 140) then performs the recovery request.

Turning specifically to FIG. 5, the method includes a smart agent receiving (501) a recovery request according to a client's defined recovery policy. The smart agent extracts (502) metadata. As mentioned above, a GUI (FIG. 1, 142) presents options to a user for recovering data. The GUI (FIG. 1, 142) is generated from the metadata (FIG. 1, 148) using a taxonomy. Further, the metadata (FIG. 1, 148) is used to determine where the data is being stored, the type of data, and the date when the data was created, among others.

The smart agent identifies (503) corresponding metadata in a data repository. According to certain principles, (FIG. 1, 148), the storage location of the actual data is determined using the metadata. In one example, the metadata uses indexes to determine the location of the stored data.

After the metadata identifies the data in a data repository, the smart agent receives (504) data from the repository. Further, the received (504) data from the data repository (FIG. 1, 160) is used to load backed up data onto the client device (FIG. 1, 150).

FIG. 6 is a flowchart of an example of a method for a backup request, according to the principles described herein. As mentioned above, a backup request is sent to a management service (FIG. 1, 110) on behalf of a client according to a defined backup policy. The client defines a policy or rules for a backup request. The management service (FIG. 1, 110) coordinates the backup request and the backup request is executed by a agent service (FIG. 1, 120) by instantiating a smart agent (FIG. 1, 140). The smart agent (FIG. 1, 140) then performs the backup request.

Turning specifically to FIG. 6, the method includes a smart agent receives (601) a backup request according to a backup policy. As mentioned above, a client defines a policy or rules for a backup request. For example, the client determines if during a backup request the data being backed up is to be encrypted or not encrypted. Further, the client determines the frequency of backups performed on the data. For example, imperative data may be backed up after a specified amount of time, such as every 15 minutes. In another example, non-imperative data may be backed up once a day. Further, the client determines how long backed up data is to be stored. For example, the client defines data may be stored for up to two years. Further, the client determines the type of files that are to be backed up. For example, files having a .pdf extension are backed up. Further, any other appropriate policy may be implemented to determine the data to be backed up.

The smart agent builds (602) metadata from backup data. As mentioned above, the smart agent (FIG. 1, 140) builds metadata (FIG. 1, 148) offline for the data being protected after backup. Building the metadata (FIG. 1, 148) offline uses a format that is open and not bound by any closed format. For example, the metadata may be built using a JavaScript Object Notation (JSON) format. In one example, JSON is used to represent simple data structures and associative arrays. By using a JSON, the smart agent's (FIG. 1, 140) data path is open and building metadata is done offline. Further, the amount of data which can be protected and the time taken to build the metadata is reduced.

The smart agent then stores (603) the backup data in a data repository. In the event of a data failure in the client device (FIG. 1, 150), the client device's data may be recovered to the state where the backup was created.

While the examples above have been described with reference to specific policy rules for time periods, frequencies, storage locations, and data types, any appropriate policy rules for time periods, frequencies, storage locations, and data types may be used in accordance with the principles described herein. Also, while the examples above have been described with reference to specific characteristics of a management service, any appropriate characteristics of a management service may be used in accordance with the principles described herein.

Further, while the examples above have been described with reference to specific attributes of a smart agent, any appropriate attribute of a smart agent may be used in accordance with the principles described herein. While the examples above have been described with reference to specific graphical user interface, any appropriate type of user interface may be used in accordance to the principles described herein. For example, the user interface may be an auditory user interface, a voice recognition user interface, a touch screen user interface, a motion detected hand gesture interface, another type of user interface, or combinations thereof.

The preceding description has been presented to illustrate and describe examples of the principles described. This description is not intended to be exhaustive or to limit these principles to any precise form. Many modifications and variations are possible in light of the above teaching.

What is claimed is:

1. A method for sending a request to a management service, comprising:
sending a request on behalf of a client to a management service that coordinates backup and recovery services in communication with a policy engine that determines backup and recovery rules; and
sending metadata about said request to said management service.

2. The method of claim 1, wherein sending said metadata about said client to said management service includes sending said metadata in an open format.

3. The method of claim 1, wherein said request is a backup request.

4. The method of claim 3, further comprising building said metadata offline in a metadata repository in response to a backup request implemented through said management service.

5. The method of claim 4, further comprising sending information from said metadata repository to said management service in response to a recovery request.

6. The method of claim 1, wherein said request is a recovery request.

7. The method of claim 1, further comprising receiving a query from said management service to determine said metadata.

8. The method of claim 1, further comprising obtaining user input to send said request through a user interface.

9. A system for sending a request to a management service, comprising:
request sending engine to send a request on behalf of a client to a management service that coordinates backup and recovery services in communication with a policy engine that determines backup and recovery rules;
receiving engine to receive a query from said management service for metadata relevant to said request; and
metadata sending engine to send said metadata to said management service.

10. The system of claim 9, wherein said request is a recovery request or a backup request.

11. The system of claim 9, further comprising a building engine to build said metadata offline in a metadata repository in response to a backup request implemented through said management service.

12. The method of claim 1, further comprising an obtaining engine to obtain user input to send said request.

13. A computer program product for sending a request to a management service, comprising:
a non-transitory computer readable storage medium, said non-transitory computer readable storage medium comprising computer readable program code embodied therewith, said computer readable program code comprising program instructions that, when executed, causes a processor to:
obtain user input to send said request with a user interface;
send a request on behalf of a client to a management service that coordinates backup and recovery services in communication with a policy engine that determines backup and recovery rules;
receive a query from said management service for metadata relevant to said request; and
send said metadata to said management service.

14. The computer program product of claim 14, further comprising computer readable program code comprising program instructions that, when executed, causes said processor to build said metadata offline in a metadata repository in response to a backup request implemented through said management service.

15. The computer program product of claim 14, wherein said request is a backup request or a recovery request.
